(19) United States
(12) Patent Application Publication
(10) Pub. No.: US 2003/0202306 A1
(43) Pub. Date: Oct. 30, 2003

(54) Heat sink for semiconductor die employing phase change cooling

(75) Inventor: Ajit Dubhashi, Redondo Beach, CA (US)

Correspondence Address: OSTROLENK FABER GERB & SOFFEN, 1180 AVENUE OF THE AMERICAS, NEW YORK, NY, 100368403

(73) Assignee: International Rectifier Corporation

(21) Appl. No.: 10/374,118

(22) Filed: Feb. 25, 2003

Related U.S. Application Data
(60) Provisional application No. 60/359,675, filed on Feb. 26, 2002.

(51) Int. Cl. H02H 5/04

(52) U.S. Cl. 361/93.8

(57) ABSTRACT

An electrical assembly, including an electrical device; and at least one self-contained phase change package in thermal contact with the electrical device, the self-contained phase change package including an enclosure and a phase change material arranged within the enclosure; wherein the phase change material is suitably selected to change phase during an overload condition.

### RELATED APPLICATIONS

The present invention is based on and claims priority to U.S. Provisional Patent Application No. 60/359,675, filed on Feb. 26, 2002, the contents of which are expressly incorporated herein by reference.

### FIELD OF THE INVENTION

This invention relates to an electrical device and method for cooling an electrical device.

### BACKGROUND OF THE INVENTION

Electrical power assemblies, such as printed circuit boards, may include at least one silicon die (e.g., such as IGBTs, MOSFETs, diodes, etc) situated on a supporting surface (e.g., a support board), and at least one heat sink to conduct heat away from the die. For this purpose, the heat sink is placed in thermal contact with the device to dissipate excess heat away from the device and keep the device within a desired temperature range.

Referring now to FIG. 1a there is seen a conventional electrical assembly 100, including a packaged electrical part 105, an isolation layer 115, a support arrangement 110 (e.g., copper) in thermal contact with the packaged electrical part 105 and the isolation layer 115, at least one electrical trace 120 situated on the isolation layer 115, and a heat-sink 125 in thermal contact with the isolation layer 115.

It should be appreciated that a DBC or IMS type support may be used in place of separate layers 110, 115, 120 with a conductive layer on its bottom, which may be coupled to the top of the heat sink 125, for example, by solder and/or by an adhesive.

Packaged electrical part 105 includes a die 130, for example, a silicon die 130, situated within an isolation housing 135, and at least one conductive lead 140 for electrically contacting at least one electrode (not shown) arranged on the die 130 to the electrical trace 120. Packaged electrical part 105 may include, for example, any conventional package, such as, a TO 220 package, a pin grid array package, a DIP package, etc.

Heat-sink 125 may include any arrangement operable to conduct and dissipate heat away from the packaged electrical part 105 to the environment. For example, as shown in FIG. 1a, the heat-sink 125 may consist of a thermally conductive metal having at least one fin 128.

Referring now to FIG. 1b, there is seen a conventional multi-chip module (MCM) 150, including at least two semiconductor dies (of which only one semiconductor die 155 is shown), a support arrangement 160 in thermal contact with the semiconductor die 155, an isolation layer 165, electrical traces 170a, 170b situated on the isolation layer 165, and a heat-sink 175 in thermal contact with the isolation layer 165. The MCM 150 differs from the electrical assembly 100 of FIG. 1a, in that no isolation housings 135 are provided to encapsulate respective semiconductor die 155. However, similar to the electrical assembly 100 of FIG. 1a, the heat-sink 175 operates to thermally conduct and/or dissipate heat away from semiconductor die 155 to the environment.

Each electrical assembly, for example, the electrical assembly 100 and the MCM 150, may be characterized by a respective thermal resistance and thermal mass (i.e., thermal capacitance). Thermal resistance is a measure of how a given power dissipation results in a given rise in temperature in a DC condition (i.e., not a transient condition), whereas thermal mass is a measure of the amount of energy (power×time), for example, Joules of energy, that may be absorbed by the system before entering into a steady state or equilibrium (i.e., the DC condition).

It is believed that the conventional heat-sinks described above are not capable of dissipating heat caused by at least some thermal overload conditions. That is, heat-sinks alone may fail to ensure that a semiconductor device operates in accordance with a desired temperature. To overcome these disadvantages, it is known to arrange a phase-change material in proximity to the semiconductor device. In this manner, the phase-change material may absorb at least some of the energy caused by a thermal overload condition, as more fully described below.

When the temperature of a material (e.g., a phase-change material) approaches a phase boundary (i.e., a temperature at which a phase change occurs), energy that would normally cause the temperature of the material to rise, is used to change the phase of the material. Thus, the energy supplied to the material during a phase change does not cause the temperature of the material to rise until all of the phase change material has changed phase. In this manner, a relatively small mass of material may absorb a large amount of energy before its temperature changes even by one degree.

Referring now to FIG. 2, there is seen a phase change diagram 200 for H₂O. As can be seen in FIG. 2, H₂O may exist in one of three distinct phases (i.e., solid (ice), liquid (water), gas (steam)). Energy 220 supplied to solid (ice) causes the temperature of the solid (ice) to rise from 0 degrees Kelvin to 273 degrees Kelvin. After reaching 273 degrees Kelvin, an additional amount of energy 205 is required to change the phase of the H₂O from solid (ice) to liquid (water), and during this phase change, the temperature of the H₂O remains constant. Once all the H₂O changes phase from solid (ice) to liquid (water), additional amount of energy 210 causes the temperature of the water to rise from 273 degrees Kelvin to 373 degrees Kelvin. After reaching 373 degrees Kelvin, an additional amount of energy 215 is required to change the phase of the H₂O from liquid (water) to gas (steam), and during this phase change, the temperature of the H₂O remains constant. Once all the H₂O changes phase from liquid (water) to gas (steam), additional energy causes the temperature of the steam to rise.

By placing a suitably selected phase change material in thermal contact with at least one portion of an electrical assembly, excess energy caused, for example, by a thermal overload condition, may be absorbed by the phase change material to change the phase of the phase change material from a first phase to a second phase, while the temperature of the electrical assembly remains constant during the phase change. In this manner, the temperature of the electrical assembly may be prevented from rising to a failure temperature during a thermal overload condition.

After the thermal overload condition subsides, the phase change material cools, which causes the material to revert back to the first phase, thereby releasing the energy the material absorbed during the overload condition. However, since the energy released by the reversion may occur at a slower rate than the rate at which the thermal overload condition provided the energy to the phase change material, the heat sink may be capable of dissipating the energy released by the phase change material, without causing the temperature of the electrical assembly to rise.

U.S. Pat. No. 6,239,502, for example, discloses a conventional phase change assisted heat sink for cooling an electrical device, which receives fluctuating amounts of electrical energy. As characterized, a phase-change heat storage material is thermally coupled to the electrical device inside a cooling channel.

Referring now to FIG. 3, there is seen an electrical assembly 300 including a conventional phase change assisted heat sink. As shown in FIG. 3, the electrical assembly 300 includes a semiconductor die 305 (i.e., an electrical device), an isolation layer 315, a support arrangement 310 (e.g., copper) in thermal contact with the semiconductor die 305 and the isolation layer 315, electrical traces 320a, 320b situated on the isolation layer 315, a heat-sink 325 in thermal contact with the isolation layer 315, a cooling channel 330 enclosing the semiconductor die 305, and a phase change material 335 arranged within the cooling channel 330.

It is believed that the conventional phase change assisted heat sink described above is disadvantageous in that the phase change material and the electrical device are arranged within an enclosed cooling channel, thereby limiting the ways in which the electrical device may be mounted on a supporting surface. In this manner, the above-described method may be expensive and difficult to couple to an electrical device arranged on a conventional supporting surface, such as a printed circuit board.

### BRIEF DESCRIPTION OF THE INVENTION

Therefore, it is an object of the present invention to provide an electrical assembly, including an electrical device; and at least one self-contained phase change package in thermal contact with the electrical device, the self-contained phase change package including an enclosure and a phase change material arranged within the enclosure; in which the phase change material is suitably selected to change phase during an overload condition.

By arranging the phase change material within a separate enclosure, the self-contained phase change package may be easily positioned and thermally coupled to the electrical device, without requiring the design of a separate cooling channel to enclose both the phase change material and the electrical device.

In accordance with an exemplary embodiment of the present invention, the electrical device of the electrical assembly described above includes a packaged electrical part, the packaged electrical part including an isolation housing and at least one semiconductor die situated within the isolation housing.

In accordance with still another exemplary embodiment of the present invention, the electrical device of the electrical assembly described above includes one of a TO 220 package, a pin grid array package, and a DIP package.

In accordance with yet another exemplary embodiment of the present invention, the electrical assembly described above is provided with a support arrangement in thermal contact with the electrical device; an isolation layer in thermal contact with the support arrangement; and a heat sink in thermal contact with the isolation layer.

In accordance with still another exemplary embodiment of the present invention, the support arrangement of the electrical assembly described above includes at least one heat transfer column, and the at least one self-contained phase change package is arranged between the electrical device and the heat sink.

### BRIEF DESCRIPTION OF THE DRAWINGS

FIGS. 1a and 1b illustrate electrical assemblies employing respective conventional heat sinks.

FIG. 2 is a phase change diagram for H₂O.

FIG. 3 illustrates an electrical assembly including a conventional phase assisted heat sink.

FIG. 4 illustrates a first exemplary electrical assembly according to the present invention.

FIG. 5 illustrates a second exemplary electrical assembly according to the present invention.

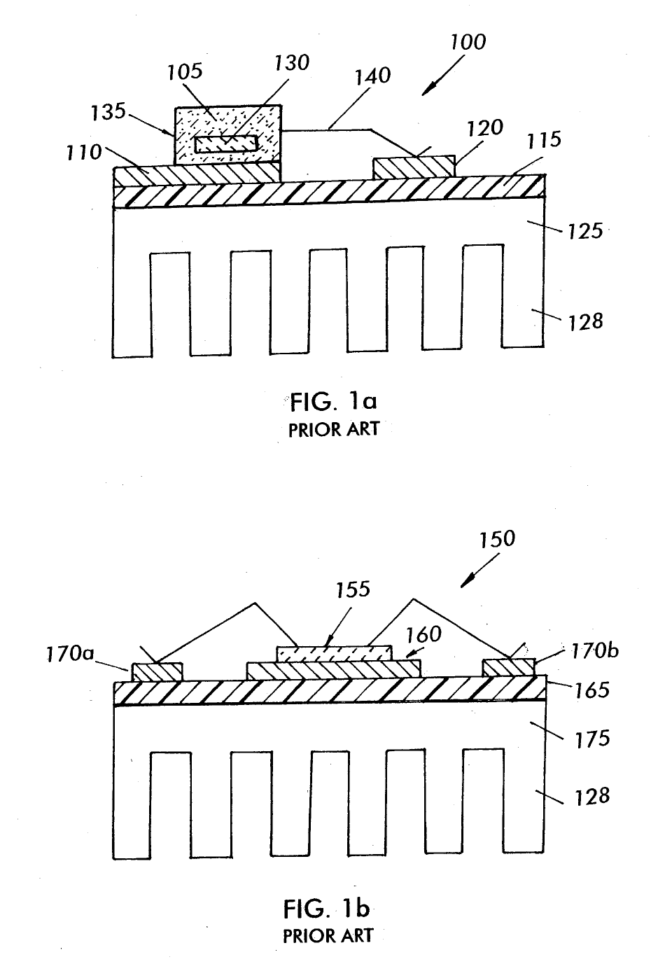

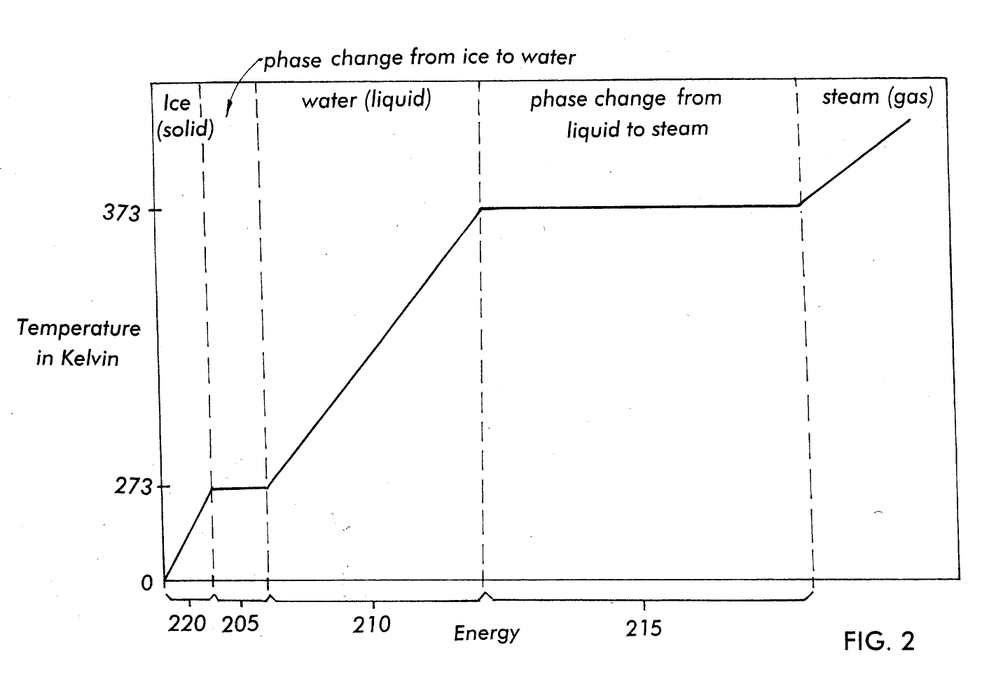

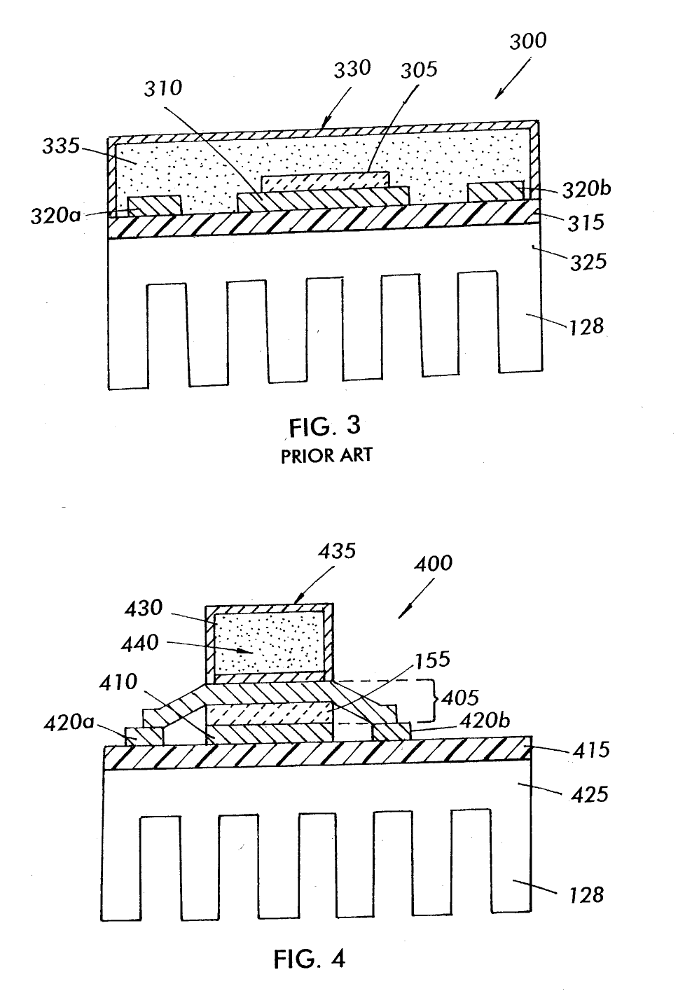

### DETAILED DESCRIPTION OF THE INVENTION

Referring now to FIG. 4, there is seen a first exemplary electrical assembly 400 according to the present invention, including a packaged electrical part 405 (i.e., an electrical device), an isolation layer 415, a conductive pad 410 (e.g., copper) in thermal contact with the packaged electrical part 405 and the isolation layer 415, at electrical traces 420a, 420b situated on the isolation layer 415, a heat-sink 425 in thermal contact with the isolation layer 415, and a self-contained phase change package 430 in thermal contact with the packaged electrical part 405. Packaged electrical part 405 may include, for example, a chip scale surface mounted device, such as the surface mounted device disclosed in U.S. patent application Ser. No. 09/819,774, the contents of which are incorporated herein by reference.

Phase change package 430 includes an enclosure 435, which may be constructed from, for example, a conductive material, such as copper and/or aluminum, and may include, for example, fins (not shown) to better dissipate heat away from the packaged electrical part 405. At least one of the walls (e.g., the bottom wall) of the enclosure may be configured to couple to the packaged electrical part 405, for example, by a thermal adhesive and/or by solder. In this manner, phase change package 430 may be configured to couple to the top, sides, and/or bottom of the packaged electrical part 405.

A phase change material 440 is arranged within the enclosure 435. For this purpose, the phase change material 440, which may include, for example, waxes, silicones, various conductivities and impurity content, solders, alloys, fillers, etc., may be poured into the enclosure 435. The phase change material 440 should be non-conductive and should not disturb normal operation of packaged electrical part 405. The amount of the phase change material 440 required depends on the thermal overload and power dissipation characteristics.

On application of energy, for example, heat, the temperature of the phase change material 440 rises to a phase change boundary temperature (e.g., the temperature at which the phase change material 440 changes phase from a solid to a liquid). Once the phase change material 440 reaches the phase change boundary temperature, additional energy (e.g., energy caused by a thermal overload condition) causes the phase change material 440 to change from a first phase to a second phase, while the temperature of the phase change material 440 remains constant at the phase change boundary temperature. Once the thermal overload condition is removed, the heat-sink 425 dissipates thermal energy from the phase change material 440, thereby causing the material 440 to revert back to the first phase.

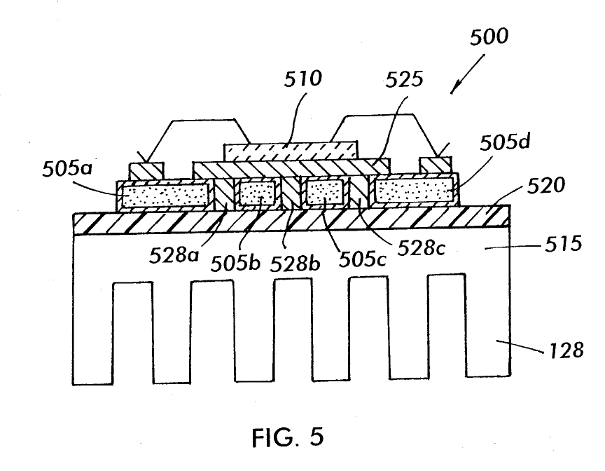

Referring now to FIG. 5, there is seen a second exemplary electrical assembly 500 according to the present invention. In this exemplary embodiment, the phase change material is provided within a plurality of self-contained phase change packages 505a, 505b, 505c, 505d situated beneath the semiconductor die 510, and the support arrangement 525 includes heat transfer columns 528a, 528b, 528c (e.g., copper and/or aluminum columns) to help dissipate heat from the semiconductor die 510 to the heat sink 515. By arranging the phase change packages 505a, 505b, 505c, 505d beneath the semiconductor die 510, heat generated by the semiconductor die 510 is absorbed by the phase change packages 505a, 505b, 505c, 505d before reaching the isolation layer 520, thereby improving the efficacy of the phase change packages 505a, 505b, 505c, 505d. In this manner, the electrical assembly 500 may be optimized for a desired thermal capacitance or DC thermal resistance.

Although the exemplary embodiments of the present invention described above employ a self-contained phase change package to dissipate heat from a semiconductor die, it should be appreciated that the present invention may be employed to dissipate heat from other devices, such as resistors, zeners, capacitors, etc.

Furthermore, although the present invention has been described in relation to particular embodiments thereof, many other variations and modifications and other uses will become apparent to those skilled in the art. It is preferred, therefore, that the present invention be limited not by the specific disclosure herein.

What is claimed is:

1. An electrical assembly, comprising:
an electrical device; and
at least one self-contained phase change package in thermal contact with the electrical device, the self-contained phase change package including an enclosure and a phase change material arranged within the enclosure; wherein the phase change material is suitably selected to change phase during an overload condition.

2. The electrical assembly according to claim 1, wherein the electrical device includes a packaged electrical part, the packaged electrical part including an isolation housing and at least one semiconductor die situated within the isolation housing.

3. The electrical assembly according to claim 2, wherein the packaged electrical part includes one of a TO 220 package, a pin grid array package, a DIP package, and a chip scale surface mounted device.

4. The electrical assembly according to claim 1, further comprising:
a support arrangement in thermal contact with the electrical device;
an isolation layer in thermal contact with the support arrangement; and
a heat sink in thermal contact with the isolation layer.

5. The electrical assembly according to claim 4, wherein the electrical device includes a packaged electrical part, the packaged electrical part including an isolation housing and at least one semiconductor die situated within the isolation housing.

6. The electrical assembly according to claim 5, wherein the packaged electrical part includes one of a TO 220 package, a pin grid array package, and a DIP package.

7. The electrical assembly according to claim 4, wherein the support arrangement includes at least one heat transfer column, and the at least one self-contained phase change package is arranged between the electrical device and the heat sink.

8. A method of constructing an electrical assembly, comprising:
providing an electrical device; and
arranging at least one self-contained phase change package in thermal contact with the electrical device, the self-contained phase change package including an enclosure and a phase change material arranged within the enclosure; wherein the phase change material is suitably selected to change phase during an overload condition.

9. The method according to claim 8, wherein the electrical device includes a packaged electrical part, the packaged electrical part including an isolation housing and at least one semiconductor die situated within the isolation housing.

10. The method according to claim 9, wherein the packaged electrical part includes one of a TO 220 package, a pin grid array package, a DIP package, and a chip scale surface mounted device.

11. The method according to claim 8, further comprising:
arranging a support arrangement in thermal contact with the electrical device;
arranging an isolation layer in thermal contact with the support arrangement; and
arranging a heat sink in thermal contact with the isolation layer.

12. The method according to claim 11, wherein the electrical device includes a packaged electrical part, the packaged electrical part including an isolation housing and at least one semiconductor die situated within the isolation housing.

13. The method according to claim 12, wherein the packaged electrical part includes one of a TO 220 package, a pin grid array package, a DIP package, and a chip scale surface mounted device.

14. The method according to claim 11, wherein the support arrangement includes at least one heat transfer column, and the at least one self-contained phase change package is arranged between the electrical device and the heat sink.

15. A self-contained phase change package, comprising:
an enclosure configured to couple to an electrical device; and
a phase change material arranged within the enclosure; wherein the phase change material is suitably selected to change phase during an overload condition.

16. The self-contained phase change package according to claim 15, wherein the phase change material includes at least one of wax, silicone, conductive, impurity, solder, alloy, and filler.
